(19) United States
(12) Patent Application Publication
(10) Pub. No.: US 2026/0246770 A1
(43) Pub. Date: Aug. 20, 2026

(54) PIN-BASED ONBOARDING OF A NETWORK DEVICE

(71) Applicant: Hewlett Packard Enterprise Development LP, Spring, TX (US)

(72) Inventors: Blaine R. Southam, Windsor, CO (US); Syama Sundararao Nadiminti, Frisco, TX (US); Nagarjun Challakere Gurudatta, Bangalore (IN)

(21) Appl. No.: 19/193,407

(22) Filed: Apr. 29, 2025

(30) Foreign Application Priority Data
Feb. 20, 2025 (IN) 202541014677

(51) Int. Cl. H04L 9/40; H04L 45/745

(52) U.S. Cl. CPC H04L 63/083; H04L 45/745; H04L 63/20

(57) ABSTRACT

A computer-implemented method may include receiving an onboarding request seeking to onboard a computing device with a management system. The method may include receiving a personal identification number (PIN) from the computing device. The PIN may have a plurality of characters, where specific characters of the PIN encode regional endpoint information and cluster information associated with the management system. The method may include extracting the regional endpoint information and cluster information from the specific characters of the received PIN. The method may include routing, based on the extracted regional endpoint and cluster information, the onboarding request to a cluster of the management system based on the extracted regional endpoint information and cluster information. The method may include validating the received PIN. The method may include transmitting, upon successful validation, onboarding information to the computing device to establish a connection between the computing device and the management system.

### BACKGROUND

Onboarding new devices to on-premises management systems and/or cloud-based management systems is an important process for businesses and organizations. The onboarding process may involve connecting new devices to an on-premises management system and/or cloud-based management system, which allows administrators to remotely manage and monitor these devices.

### BRIEF DESCRIPTION OF THE DRAWINGS

For a more complete understanding of this disclosure, and advantages thereof, reference is now made to the following descriptions taken in conjunction with the accompanying drawings, in which: FIG. 1 is a block diagram of a PIN-based onboarding system, according to some implementations.

FIG. 2 is a block diagram of a management system of a PIN-based onboarding system, according to some implementations. FIG. 3 is a flowchart of a method for PIN-based onboarding, according to some implementations.

FIG. 4 is a block diagram of an example PIN structure for PIN-based onboarding, according to some implementations. FIG. 5 is a block diagram of a PIN-based onboarding system, according to some implementations.

FIG. 6 is a sequence diagram illustrating PIN-based onboarding method, according to some implementations. FIG. 7 is a flowchart of a method for PIN-based onboarding, according to some implementations.

FIG. 8 is a block diagram of a PIN-based onboarding system, according to some implementations.

### DESCRIPTION

The following disclosure provides many different examples for implementing different features. Specific examples of components and arrangements are described below to simplify the present disclosure. These are merely examples and are not intended to be limiting.

The present disclosure relates to a PIN-based onboarding system for management systems, services, or platforms, e.g., on-premises, cloud-based, or a combination of both, referred to simply as management systems. The PIN-based onboarding system addresses challenges associated with securely and efficiently onboarding computing devices to management systems across various geographic regions and data center clusters.

Typically, onboarding new devices to management systems involves a multi-step process where manual configuration on both the device side and the management side may be appropriate. The onboarding process may include entering relatively lengthy identification codes or credentials on the devices to be managed, which can be time-consuming and error-prone, especially in large-scale deployments.

Relatively more streamlined and secure methods of device onboarding may be appropriate for modern management systems. Such relatively streamlined and secure methods may reduce the complexity of the onboarding process, minimizing the potential for human error, ensuring the security of the onboarding credentials, and accommodating a relatively wide range of devices and network environments that may be present in modern information technology infrastructures. Additionally, due to the global nature of many organizations, it may be appropriate to have onboarding solutions that can efficiently handle devices across different geographic regions and data center clusters. In certain implementations, the process of onboarding computing devices to a management system may be performed using a unique personal identification number (PIN). The PIN solutions may allow a relatively streamlined, secure, and efficient method for coupling devices to management platforms across various geographic regions and data center clusters. This PIN-based approach may simplify the onboarding process for clients while maintaining a relatively high level of security and flexibility. The PIN-based onboarding system may generate a PIN comprising a plurality of characters, each character or set of characters serving a specific purpose in the onboarding process.

In certain implementations, the PIN-based onboarding system generates a unique PIN for each onboarding request. In certain implementations, the PIN encodes information about an intended management region and cluster of the device, allowing for intelligent routing without requiring users to understand or input detailed infrastructure information.

In certain implementations, the PIN structure incorporates several security features, including a customizable expiration time and a check digit for error detection. One of the advantages of the PIN-based onboarding system may be its ability to detect common input errors such as transposition, twin, jump transposition, jump twin, and/or phonetic errors without requiring communication with the management system. Such local validation capability may reduce network traffic and improves the user experience by providing immediate feedback. In certain implementations, the PIN-based onboarding system provides PIN uniqueness within, e.g., a 365-day period, reducing the risk of unauthorized access attempts. Furthermore, the same PIN can be used to onboard multiple devices while it remains valid, streamlining the process for large-scale deployments. To maintain security, new PINs may be checked against a database of existing PINs to prevent collisions.

In some implementations, the PIN-based onboarding system may incorporate a security feature which provides a use count. This feature allows a specific PIN to be used for onboarding a number of devices, after which the PIN may become invalid. The use count can be any integer number equal or greater than one, providing flexibility to accommodate various deployment scenarios. In certain implementations, the PIN-based approach for onboarding can allow for the disabling of secure shell protocol on the network device being onboarded, thereby reducing the attack surface and improving overall system security. In certain implementations, the PIN generation process uses an algorithm that provides a reliable method for error detection. By simplifying the onboarding process for end-users while maintaining robust security measures, the PIN-based onboarding system can improve the management of large-scale, geographically distributed device networks in on-premises and/or cloud management environments.

FIG. 1 depicts a PIN-based onboarding system 100 configured for network management and device onboarding. In certain implementations, the PIN- based onboarding system 100 includes several interconnected components that may work together to facilitate the management of multiple network devices across various regions and clusters.

In certain implementations, the PIN-based onboarding system 100 includes a managed network 102, which serves as the infrastructure for data communication and network device coordination. Within the managed network 102, multiple network devices 104 may operate to perform various network functions. The network devices 104 may include a first network device 104A, a second network device 104B, and an (n-1)-th network device 104N-1, representing the scalability of the PIN-based onboarding system 100 to accommodate numerous devices. The network device 104 may be a processing device that facilitates the transfer of data across the network 102. For example, the network device 104 may include a router, a switch, an access point, a firewall, a modem, or another suitable type of the network device. In certain implementations, the network device 104 may direct data packets along the network 102, couple multiple devices to the network 102, manage data traffic, provide wireless connectivity, provide network security, couple networks 102 to the internet, and/or perform other suitable operations. The network device 104 may be configured to perform a range of functionalities, including those typically associated with hosts and other devices. For example, the network device 104, such as a multifunctional router, may serve as a server, hosting applications or services directly on the network device 104. In some implementations, the network device 104 may provide data routing, switching capabilities, and/or host network management software and tools. The network devices 104 may vary in terms of their data transfer speed, range of connectivity, security features, or the specific network protocols they support. In certain implementations, the PIN-based onboarding system 100 is configured to allow for the relatively seamless integration of new devices. A new network device 104N may be added to the managed network 102 through an onboarding process. This process may involve communicatively coupling the new network device 104N to the managed network 102 and initializing it as an active component of the PIN-based onboarding system 100 topology. While illustrated in a single box, it is understood that the network 102 can be arranged over very large geographic areas.

To facilitate communication between the network devices 104 and other components of the PIN-based onboarding system 100, interface(s) 110 may be provided. The interface 110 may be communicatively coupled to a network 112, which in turn links to a client manager 114 and a management system 116. The client manager 114 may assist in overseeing the communication between the network devices 104 and the management system 116. In some implementations, the client manager 114 may be a handheld device such as a smartphone, tablet, or other similar portable computing devices. These mobile devices may run specialized applications that allow administrators to manage and monitor network devices remotely. In some implementations, the client manager 114 may be a device configured to receive the PIN from the management system 116. Such device may serve as an intermediary between the management system 116 and the new network device 104N being onboarded. When a PIN is generated by the management system 116, it may be transmitted to the client manager 114, which can then display or relay the PIN to the user or administrator responsible for onboarding new devices. In some implementations, such functionality of the client manager 114 allows for secure distribution of PINs and provides a convenient interface for users to obtain the appropriate onboarding credentials. The portability of client manager 114 may allow on-the-go management, allowing administrators to respond quickly to issues or perform routine tasks from any location with network connectivity. In some cases, these handheld devices may use touch interfaces, biometric authentication, or other mobile-specific features to improve usability and security in managing the network infrastructure. In other cases, the client manager 114 may be a software application running on a separate server or workstation that interfaces between the network devices 104 and the management system 116. This application may provide a user interface for administrators to monitor and control the network devices across the managed network 102. For example, the client manager 114 can be part of the managed network 102, i.e., it could be one of the network devices 104.

The client manager 114 may include functionality to authenticate users, manage access permissions, and enforce security policies for interacting with the managed network devices 104. Applying updates or configuration changes across multiple network devices 104 may be performed relatively simultaneously using the client manager 114.

In some implementations, the client manager 114 may serve as a data aggregator, collecting telemetry and status information from the managed network devices 104 and presenting it in a consolidated dashboard view. Such data aggregation may allow for relatively easier monitoring of the overall health and performance of the managed network 102. The client manager 114 may provide application programming interfaces (APIs) or integration points for other enterprise systems to interact with the managed network devices 104. For example, the client manager 114 may allow a ticketing system to automatically create maintenance requests based on the network device 104 status.

In some aspects, the client manager 114 may handle the initial provisioning and onboarding of new network devices 104N to the managed network 102. Such initial provisioning and onboarding may include functions such as assigning internet protocol addresses, applying baseline configurations, and registering the new network devices 104N with the management system 116. The client manager 114 may implement caching or local processing capabilities to reduce latency when interacting with remote devices. It may also provide store-and-forward functionality to handle temporary network disruptions between the managed network devices 104 and the central management system 116.

In certain implementations, the client manager 114 may provide translation or abstraction layers to allow management of heterogeneous device types through a common interface. The translation or abstraction layers of the client manager 114 may allow a relatively consistent management practices across the network devices 104 from different vendors or with varying capabilities.

The interfaces 110 represent any suitable computer element that can receive information from the network 112 and transmit information through a network 112, or both. The interfaces 110 may facilitate wireless and/or wired communication. The interfaces 110 may represent any port or connection, real or virtual, including any suitable combination of hardware, firmware, and software, including protocol conversion and data processing capabilities, to communicate through a LAN, WAN, or other communication system that allows information to be exchanged. In certain implementations, at least one of interfaces 110 is configured to communicate through the network 112 to the network devices 104.

The network 112 may include any suitable wired or wireless communication medium for the components of the PIN-based onboarding system 100 to communicate with one another. For example, the network 112 may include any suitable combination of a bus or communication network. In certain implementations, the network 112 can be the Internet.

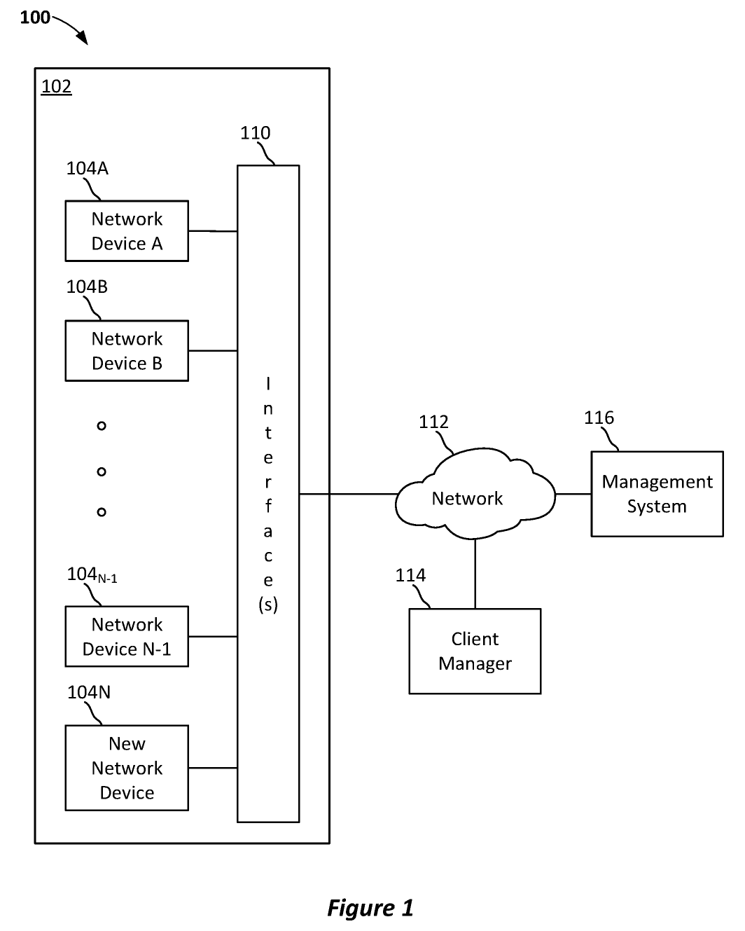

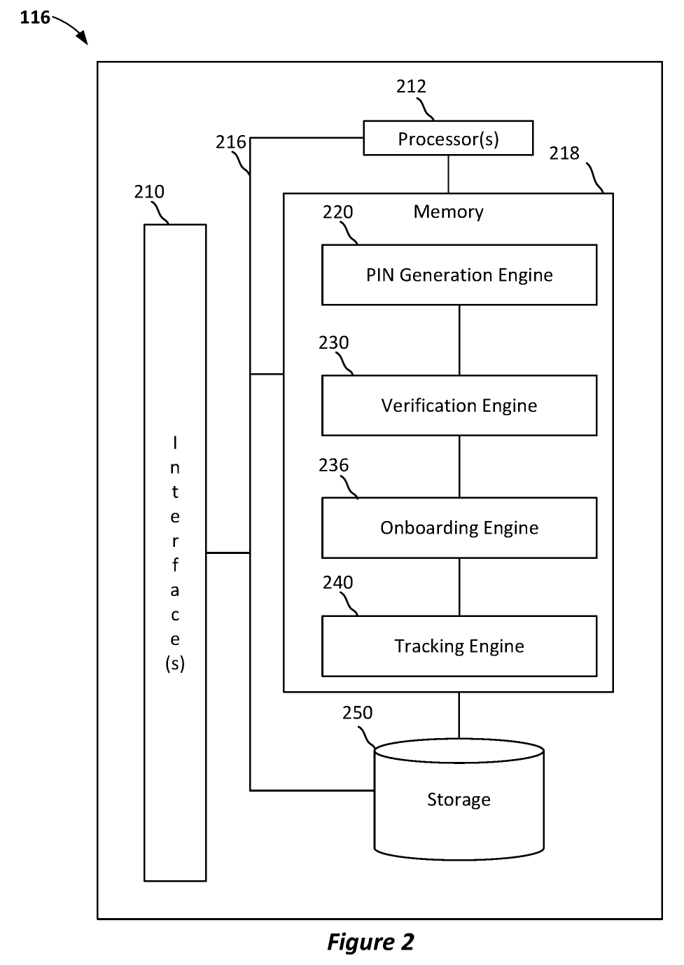

FIG. 2 illustrates an example implementation of the management system 116. In some implementations, the management system 116 may be an on-premises management system or a cloud-based management system. In some implementations, the management system 116 may include one or more processor(s) 212 and a non-transitory computer-readable medium 218 that stores programming for execution by the one or more processors. This configuration allows the management system 116 to perform various operations, such as PIN generation, validation, and device onboarding. In some implementations, the management system 116 includes several interconnected components that work together to facilitate the PIN-based onboarding process for computing devices (e.g., the new network device 104N). In some implementations, the management system 116 can also be referred to as the management service. This terminology may be used interchangeably to describe the same entity that performs device onboarding, management, and related functions.

The processor(s) 212, memory 218, and one or more interfaces 210 may communicate using one or more communication links 216. The processor(s) 212 may be any component or collection of components configured to perform computations and/or other processing-related tasks. The processor(s) 212 can be, for example, a microprocessor, a microcontroller, a control circuit, a digital signal processor, an FPGA, an ASIC, an SoC, or combinations thereof. The processor(s) 212 may include one or more processing cores. The processor(s) 212 may include any suitable number of processors, or multiple processors may collectively form a single processor 212.

The memory 218 may include any suitable combination of volatile memory, non-volatile memory, and/or virtualizations thereof. For example, the memory 218 may include any suitable combination of magnetic media, optical media, RAM, ROM, removable media, and/or any other suitable memory device. The memory 218 may include data structures used to organize and store all or a portion of the stored data.

In certain implementations, the interface(s) 210 allow interaction between the management system 116 and other components of the PIN-based onboarding system 100. As an example, the interface(s) 210 may facilitate communication with the network devices 104, the client manager 114, and other systems external to the management system 116. In some cases, the interface(s) 210 may receive requests for PIN generation and transmit generated PINs to authorized users or devices.

In certain implementations, the interfaces 210 represent any suitable computer element that can receive information from a communication link 216 and transmit information through a communication link 216, or both. The interfaces 210 may represent any port or connection, real or virtual, including any suitable combination of hardware, firmware, and software, including protocol conversion and data processing capabilities, to communicate through a LAN, WAN, or other communication system that allows information to be exchanged. The interfaces 210 may facilitate wireless and/or wired communication.

The communication links 216 may include any suitable wired or wireless communication medium for the components of the management system 116 to communicate with one another. In certain implementations, at least one of interfaces 210 is configured to communicate through the communication link 216 to the network 112. For example, the communication links 216 may include any suitable combination of a bus or communication network.

In certain implementations, the programming stored in memory 218 may implement a PIN generation engine 220. The PIN generation engine 220 may be configured to create unique PINs for device onboarding. In some cases, the PIN generation engine 220 may encode regional endpoint information and cluster information into specific characters of the PIN. The PIN generation engine 220 may also generate cryptographically random characters to improve security.

In certain implementations, the programming stored in memory 218 may implement a verification engine 230 that authenticates and verifies the received PINs. The verification engine 230 may implement the various checks such as uniqueness verification and expiration checking. The verification engine 230 may validate PINs received through the interface(s) 210 during the onboarding process. In some cases, the verification engine 230 may check the uniqueness of the PIN, verify its expiration status, and confirm the accuracy of the encoded information.

In certain implementations, the programming stored in memory 218 may implement an onboarding engine 236. The onboarding engine 326 may be configured to compile and transmit the onboarding information to the new network devices 104N upon successful PIN validation.

In some implementations, the architecture of the management system 116 includes other components to facilitate the onboarding process implemented by the onboarding engine 236. As an example, a transmitter component may handle the secure distribution of the generated PIN to the client manager 114 and/or authorized user. A receiver component may be configured to accept incoming PIN-based onboarding requests on behalf of the computing devices (e.g., the new network device 104N). The receiver may be distributed across multiple regional endpoints to allow efficient handling of requests from various geographic locations.

In some implementations, the PIN-based onboarding request can originate from either the new network device 104N or the client manager 114. As an example, when the new network device 104N initiates the onboarding request, the new network device 104N may use the PIN to directly connect to the appropriate regional endpoint and cluster of the management service (e.g., of the management system 116). In some implementations, the client manager 114 may initiate the onboarding request on behalf of the new network device 104N. In such scenario, the client manager 114 may receive the PIN from the management system 116 and coordinate the onboarding process.

The management system 116 may include other components such as a router for directing requests to the appropriate clusters based on PIN information, an account assignment component for automating the association of the new network devices 104N with client accounts, and/or a subscription assignment component for handling service activations or assignments.

Upon successful validation of the PIN, the onboarding engine 236 may proceed to transmit onboarding information to the computing device (e.g., the new network device 104N). In some implementations, the onboarding information may include details and credentials, which may be appropriate for the new network device 104N to establish a secure connection to the management system 116. The information may include network configurations, security certificates, and other parameters tailored to the specific region and cluster encoded in the PIN. In some implementations, the new network devices 104N receive the appropriate configuration data and credentials to establish a secure connection to the management system 116. The architecture of the onboarding engine 236 may be configured to handle the routing of onboarding requests based on the information encoded in the PIN.

When an onboarding request is received on behalf of a computing device104N, it may be directed to a regional endpoint determined by the region information encoded in the PIN. This intelligent routing allows the device onboarding request to be handled by the appropriate regional infrastructure, improving performance and adhering to potential data residency requirements. Once the request reaches the correct regional endpoint, it may be further routed to a specific cluster within that region, as determined by the cluster information encoded in the PIN. This multi-level routing approach allows for fine-grained control over the locations where the new network device 104N may be managed within the on- premises and/or cloud infrastructure, allowing efficient resource allocation and management.

In some implementations, the onboarding engine 236 may allow future- proofing through the use of updatable mapping tables. This feature of the onboarding engine 236 allows the new network devices 104N to adapt to changes in the infrastructure of the management system 116 without requiring software updates.

When the new network device 104N encounters a region code in the PIN that is not recognized in its current mapping table, the new network device 104N may initiate a process to retrieve an updated mapping table from a known endpoint. This updated table may include information about new regions or changes to existing regional endpoints. By implementing such dynamic update capability, the onboarding engine 236 may accommodate the addition of new regions or modifications to the existing infrastructure without impacting the onboarding process for the new network devices 104N with older mapping tables. In some implementations, this approach improves the scalability and longevity of the PIN-based onboarding system 100, allowing the PIN-based onboarding system 100 to evolve alongside the expanding on-premises and/or cloud infrastructure.

Certain implementations may include automated account and subscription assignment features, further streamlining the onboarding process. As an example, upon successful validation of the PIN and routing of the request, the onboarding engine 236 may automatically assign the new network device 104N to the appropriate client account. This automation may eliminate or substantially reduce the need for manual account association steps, reducing the potential for errors and saving time for clients and/or system administrators. In some implementations, the onboarding engine 236 may automatically assign a subscription to the new network device 104N based on selections made during the PIN generation process. This feature may allow a relatively seamless integration of the new network device 104N into existing service plans of the client and/or the activation of new services as part of the onboarding process.

In certain implementations, the programming stored in memory 218 may implement a tracking engine 240 that may monitor PIN usage and status within the management system 116. In some cases, the tracking engine 240 may log PIN generation events, track successful onboarding attempts, and maintain records of PIN expiration dates.

In certain implementations, the management system 116 includes a storage component 250. The storage 250 may maintain databases and store information required for the operation of the management system 116. In some cases, the storage 250 may include records of generated PINs, user account information, and mapping tables for regional endpoints and clusters. The storage 250 is typically a non-volatile memory such as a solid state drive or hard disk drive, although other memory technologies can be used.

In some cases, the PIN generation engine 220 may allow a user to choose which subscription to associate with a device upon onboarding. This information may be encoded within the PIN and/or stored in the storage 250 for retrieval during the onboarding process. The verification engine 230 may then use this information to automatically assign the appropriate subscription when validating the PIN during device onboarding.

In some cases, management system 116 may use APIs to link new network device 104N to a client account and assign the new network device 104N for management by the management system 116. This automation may streamline the onboarding process by reducing manual setup steps previously required of the client.

When the management system 116 is an on-premises management system, the management system 116 may be installed and operated on the organization local servers or private network. In the on-premises configuration, the PIN-based onboarding process may function similarly to a cloud-based setup. The PIN may encode information about the local network topology, specific server clusters, or departments within the organization. The new network device 104N may use this encoded information to connect to the appropriate segment of the on- premises management system 116.

In some implementations, the components the on-premises management system 116 for PIN generation, validation, and device onboarding, such as the PIN generation engine 220, the verification engine 230, and the storage 250 may operate within the organization own infrastructure, providing a relatively self-contained management solution.

In some implementations, the on-premises management system 116 may provide data locality, e.g., for companies with strict data sovereignty requirements. In some implementations, the on-premises deployment can offer relatively lower latency and faster response times for devices within the same local network. In some implementations, organizations may have more flexibility to customize and integrate the on-premises management system 116 with other on-premises tools and systems.

For industries with specific regulatory requirements, the on-premises solution may meet compliance standards more efficiently in comparison to the cloud- based solution by keeping data and processes in-house. In some implementations, the on-premises management system 116 can continue to function if internet connectivity is lost, allowing uninterrupted management of local devices.

When the management system 116 is implemented as a cloud-based solution, organizations may leverage the scalability, flexibility, and accessibility of cloud computing for their device management needs. As a cloud-based system, the management system 116 may be hosted on remote servers and accessed via the internet.

In this cloud-based configuration, the PIN may encode information about specific cloud regions, data centers, or virtual private clouds where the management system 116 is hosted. The new network device 104N may use this encoded information to connect to the appropriate segment of the cloud-based management system 116.

The cloud-based management system 116 may distribute its components across multiple regions or data centers for improved performance and redundancy. For example, the PIN generation engine 220, the verification engine 230, and the storage 250 may be replicated across different geographic locations, allowing for relatively faster response times and increased reliability.

In comparison to the on-premises solutions, the cloud implementation of the management system 116 may facilitate more efficient integration with other cloud-based services, potentially offering a more comprehensive and interconnected management ecosystem. In some implementations, the cloud infrastructure can scale up or down more efficiently to accommodate changing numbers of managed devices without requiring on-site hardware upgrades.

In some implementations, administrators and various devices can connect to the cloud-based management system 116 from anywhere with, e.g., internet access, facilitating remote management and distributed teams. In some implementations, the cloud provider can handle software updates and maintenance, allowing the cloud-based management system 116 to run the latest version with reduced downtime.

In some implementations, organizations using the cloud-based management system 116 may reduce capital expenditures on hardware and benefit from pay-as-you-go pricing models. In some implementations, cloud providers may offer relatively robust backup and recovery options, improving data protection and business continuity.

FIG. 3 depicts one example implementation of the management system 116. Here, the memory 218 stores instructions 302 through 308. In certain implementations, the memory 218 may store instructions for generating and providing a PIN for device onboarding. The memory 218 may store instructions 302, which involve receiving a request from a user for a PIN to be used for onboarding compute resources or computing devices (e.g., the new network devices 104N) in a management service (e.g., the management system 116). The instructions 302 may be initiated through a remote interface coupled to the management system 116. In some implementations, the instructions 302 are executed to obtain the PIN, which then may be used by the network device 104N to be onboarded to the management system 116. The processor(s) 212 may process this request and prepare for PIN generation.

In certain implementations, the memory 218 may store instructions 304, during which the processor(s) 212 generates a PIN in response to the request. The generated PIN may have between six and twenty characters, providing flexibility in the PIN structure. While the generated PIN may have between six and twenty characters as described, in some implementations the PIN may potentially have fewer than six or more than twenty characters. The specific number of characters in the PIN may be adjusted based on various factors such as security requirements, the amount of information to be encoded, system constraints, or user experience considerations. The flexibility in PIN length allows the PIN-based onboarding system 100 to be configured to different use cases, operational needs, or evolving security standards. The exact range of characters may vary depending on the specific implementation and configuration choices made for the PIN generation process.

In some cases, the PIN may include a nine-digit PIN, balancing security and usability. The processor(s) 212 may use various strategies to create the PIN components. During PIN generation, the processor(s) 212 may generate one or more characters to provide regional endpoint information. In some cases, two characters may be dedicated to encoding the regional information. The processor(s) 212 may generate one or more characters to provide cluster information, which in some implementations may be a single character. These regional and cluster identifiers allow for efficient routing during the onboarding process.

The processor(s) 212 may generate a plurality of characters that are unique to the PIN, improving security. In some cases, the processor(s) 212 may generate cryptographically random characters for the remaining positions in the PIN. In certain implementations, the randomness increases the PIN resistance to guessing or brute-force attacks.

The processor(s) 212 may generate one or more characters as a check digit, which can be used for local validation of the PIN. As an example, one of the characters of the PIN may be calculated as a check digit. In some implementations, the check digit serves as a built-in error detection mechanism, allowing for immediate validation of the PIN integrity on the client side without communicating with the management service.

In some implementations, the check digit in the PIN may be calculated using a specific algorithm designed to detect common input errors. In some implementations, numerical values may be assigned to each character in the PIN, including letters and numbers. For example, A-Z may be assigned values 1-26, and 0-9 may retain their numerical values.

In some implementations, each character assigned value is multiplied by a weight factor. The weight factors may alternate between odd and even numbers, such as 1, 2, 1, 2, and so on. In some implementations, the results of these multiplications may be summed. In some implementations, a modulo operation on the sum using a predetermined number may be performed. E.g., modulo 11may be performed, during which a remainder is found when the referenced sum is divided by 11.

In some implementations, the result of the modulo operation may be subtracted from the predetermined number to get the check digit. If the result is ten (10), a special character (e.g., X) may be used instead of ten (10). In some cases, the specific weights or a modulo value used in the calculation may be adjusted based on the desired level of error detection or the characteristics of the PIN structure.

The check digit calculation may be performed when generating the PIN and can be verified when the PIN is entered into the new networking device 104N. By recalculating the check digit using the entered characters and comparing it to the provided check digit, the PIN-based onboarding system 100 can relatively quickly identify potential input errors without needing to communicate with the management service. This method may allow for the detection of various types of input errors, including transposition of adjacent digits, twin errors (where one digit is mistakenly entered twice), and jump transpositions (where non-adjacent digits are swapped).

To improve readability and reduce input errors, the PIN generated by the processor(s) 212 may exclude visually ambiguous characters such as "I", "1", "0", "o", and "O". This consideration improves the user experience during PIN entry. In certain implementations, the memory 218 may store instructions 306 for the processor(s) 212 to assign the generated PIN to an account of the user. This assignment may involve storing the PIN and its associated account information in the storage 250.

In certain implementations, the memory 218 may store instructions 308 for the processor(s) 212 to provide the PIN to the user. The instructions 308 may be initiated through a display on the new network device 104N, or via a secure communication channel to a preferred contact method of the user.

In some implementations, the memory 218 may store temporary data during PIN generation and the final PIN-to-account mappings. The processor(s) 212 and memory 218 may work together to provide secure and efficient PIN generation and provision, facilitating the onboarding of new network devices 104N to the management service (e.g., the management system 116).

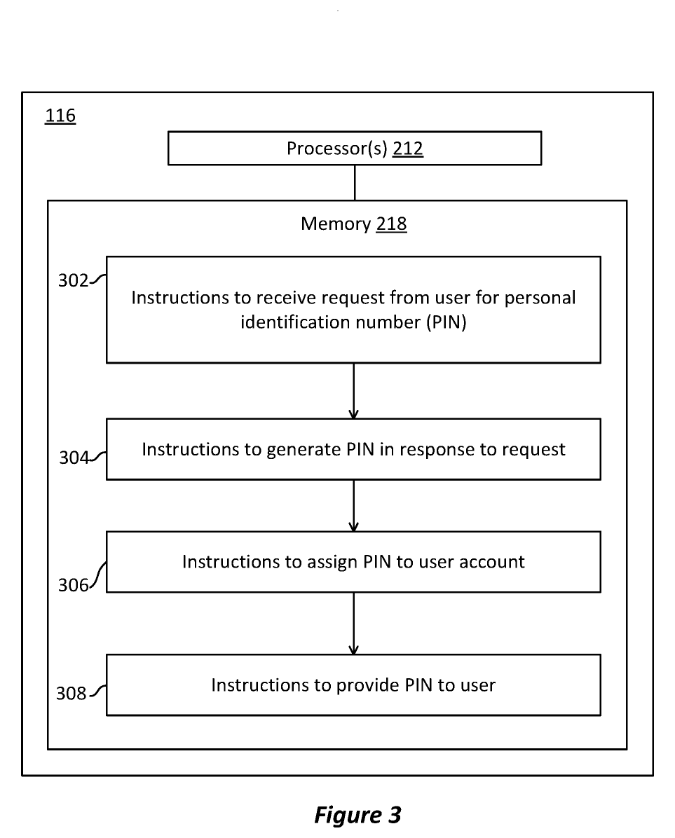

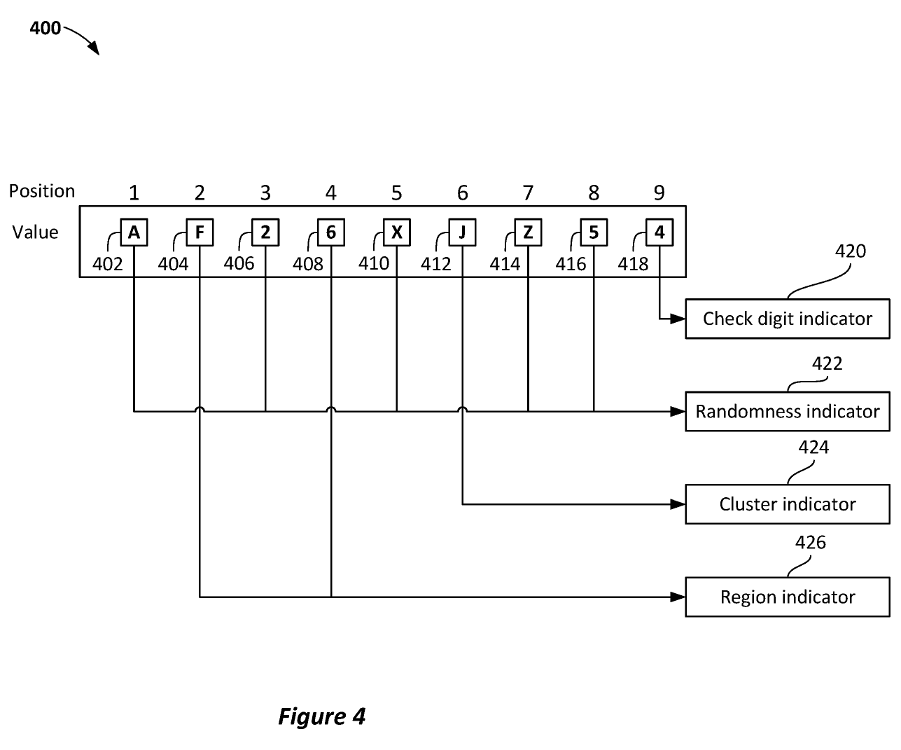

FIG. 4 depicts an example PIN structure 400 used for device onboarding in the PIN-based onboarding system 100. In certain implementations, the PIN structure 400 includes nine-character positions, each serving a specific purpose in encoding information about the device and its intended management environment.

In some cases, the PIN may include nine characters 402 through 418, configured to encode information about the region and cluster associated with the client account. This structure may include two characters 404 and 408 dedicated to encoding the region, allowing for about 1000 different regions to be represented by the PIN. Another character 412 may be used to encode the cluster indicator 424 within the specified region, providing further granularity in directing the new network device 104N to the appropriate management infrastructure. In some implementations, to improve security and uniqueness, the PIN may include five cryptographically random characters 402, 406, 410, 414, and 416. In some implementations, the characters 402, 406, 410, 414, and 416 may create a relatively large number of possible combinations, reducing the likelihood of PIN collisions and unauthorized access attempts. The use of cryptographic randomness may add an additional layer of security to the PIN generation process.

While the PIN structure 400 shown in FIG. 4 illustrates a nine-character PIN, the number of characters in the PIN may vary in different implementations. In some cases, the PIN may include more than nine characters to provide additional security or encode more information. Conversely, in other implementations, the PIN may have fewer than nine characters to simplify user input or meet specific system requirements. The exact number of characters in the PIN structure may be adjusted based on various factors such as the desired level of security, the amount of information to be encoded, and the ease of use for end-users. The flexibility in PIN length allows the PIN-based onboarding system 100 to be configured to various operational needs and security policies.

A first position 402 of the PIN structure 400 may include the character "A." In some cases, the first position 402 may be a random character, as indicated by a randomness indicator 422 associated with the first position 402. This random character 402 may improve the security of the PIN by increasing its uniqueness. In certain implementations, five random characters 402, 406, 410, 414, and 416 may create, for example, 33,554,432 combinations (i.e., 325, where 32 is the summation of 24 alpha characters and eight numerical characters). However, the number of combinations may not be limited to this specific value. In some cases, the management system 116 may be configured to generate a different number of combinations based on various factors such as security requirements, character set size, or the number of random characters used. The number of possible combinations may be larger or smaller depending on the specific implementation and configuration choices made for the PIN generation process.

In certain implementations, a second position 404 of the PIN structure 400 displays the character "F." In certain implementations, the second position 404 is associated with a region indicator 426, such that the second position 404 encodes information about the regional endpoint for the new network device 104N. In some cases, the second position 404, along with a fourth position 408, may provide the regional endpoint information for the management service.

In certain implementations, a third position 406 of the PIN structure 400 shows the character "2." Similar to the first position 402, the third position 406 may be associated with the randomness indicator 422, indicating that the character 406 may be randomly generated to further improve PIN security.

In certain implementations, the fourth position 408 includes the character "6." Similar to the second position 404, the fourth position 408 may be associated with the region indicator 426. In some cases, the second position 404 and the fourth position 408 together may provide two characters of regional endpoint information, allowing for a relatively large number of possible regions to be encoded. In certain implementations, the characters 404 and 408 may encode, for example, 1024 regions (i.e., 322, where 32 is the summation of 24 alpha characters and eight numerical characters). However, the number of regions may not be limited to this specific value. In some cases, the management system 116 may be configured to generate a different number of regions based on various factors such as region requirements, character set size, or the number of random characters used. The number of possible regions may be larger or smaller depending on the specific implementation and configuration choices made for the PIN generation process.

In certain implementations, a fifth position 410 of the PIN structure 400 displays the character "X." The fifth position 410 may be associated with the randomness indicator 422, continuing the pattern of interspersing random characters throughout the PIN to increase uniqueness and security of the PIN.

In certain implementations, a sixth position 412 of the PIN structure 400 includes the character "J." The sixth position 412 may be associated with a cluster indicator 424, showing that this position encodes information about the specific cluster within the region where the new network device 104N will be managed. In some cases, this single character may provide sufficient information to identify the appropriate cluster within the management service. In certain implementations, the cluster character 412 may encode, for example, 32 clusters within each region, where 32 is the summation of 24 alpha characters and eight numerical characters. However, the number of clusters may not be limited to this specific value. In some cases, the management system 116 may be configured to generate a different number of clusters based on various factors such as cluster requirements, character set size, or the number of random characters used. The number of possible clusters may be larger or smaller depending on the specific implementation and configuration choices made for the PIN generation process.

In certain implementations, a ninth position 418 of the PIN structure 400 includes the character "4." The ninth position 418 may be associated with a check digit indicator 420, showing that this character serves as a check digit for the entire PIN. In some cases, the check digit may be calculated based on the other eight characters of the PIN, providing a method for local validation of the PIN integrity without requiring communication with the management service. The relatively compact nature of the PIN, compared to traditional lengthy identification codes, may reduce the potential for input errors and improve the user experience.

FIG. 5 depicts one example implementation of the management system 116. Here, the memory 218 stores instructions 502 through 512 to perform PIN generation and assignment operations.

In certain implementations, the memory 218 may store instructions 502 for the processor(s) 212 to generate one or more characters to provide regional endpoint information. In some cases, the processor(s) 212 may access a predefined mapping table stored in the memory 218 to associate specific character combinations with different regional endpoints.

In certain implementations, the memory 218 may store instructions 504 for the processor(s) 212 to generate one or more characters to provide cluster information. The processor(s) 212 may consult another mapping table in the memory 218 to assign characters that represent different clusters within the selected region.

In certain implementations, the memory 218 may store instructions 506 for the processor(s) 212 to generate a plurality of characters that are unique to the PIN. In some cases, the processor(s) 212 may use a cryptographic random number generator to create these characters, providing a relatively high level of uniqueness and security for each PIN.

In certain implementations, after generating the unique characters, the memory 218 may store instructions 508 for the processor(s) 212 to generate one or more characters as a check digit. The processor(s) 212 may apply a specific algorithm, stored in the memory 218, to calculate the check digit based on the previously generated characters.

In certain implementations, the PIN includes nine characters as shown in FIG. 4, with two characters providing regional endpoint information, one character providing cluster information, five characters serving as random characters to provide a unique PIN identifier, and one character serving as a check character. e.g., a check digit. This structure of the PIN may allow encoding of appropriate routing information while maintaining a relatively high level of security and uniqueness for each generated PIN.

In some implementations, the memory 218 may store instructions 510 for the processor(s) 212 to assign the PIN to a user account. In some cases, the processor(s) 212 may store the generated PIN along with the associated user account information in the storage 250 illustrated in FIG. 2.

In some implementations, the memory 218 may store instructions 512 for the processor(s) 212 to provide the PIN to the user. The processor(s) 212 may display the PIN on a user interface of the client manager 114 or transmit the PIN through a secure communication channel.

Throughout this process, the processor(s) 212 may validate the generated PIN in several ways. In some cases, the processor(s) 212 may extract the regional endpoint information and cluster information from the certain characters of the PIN and verify that the extracted information corresponds to valid regional endpoints and clusters within the management service. This verification may involve checking against a list of valid endpoints and clusters stored in the memory 218.

The processor(s) 212 may validate the generated PIN by verifying its uniqueness within the management service. In some cases, the processor(s) 212 may compare the newly generated PIN against a database of existing PINs stored in the memory 218 to confirm no duplicates exist.

In some implementations, the processor(s) 212 may validate the generated PIN by verifying that the PIN has not expired. The storage 250 may store expiration parameters for PINs, which the processor(s) 212 may check during the validation process.

The processor(s) 212 may use the check digit generated in step 508 to detect errors in other characters of the PIN. In some cases, the processor(s) 212 may recalculate the check digit using the other characters of the PIN and compare it to the generated check digit to provide the PIN integrity.

In some cases, the processor(s) 212 may associate the PIN with a user subscription, linking the new network device 104N to specific services or access levels within the management service.

By following the instructions 502 through 512 and validation processes, the processor(s) 212 and memory 218 may work together to generate and manage secure, unique PINs for device onboarding in the management service.

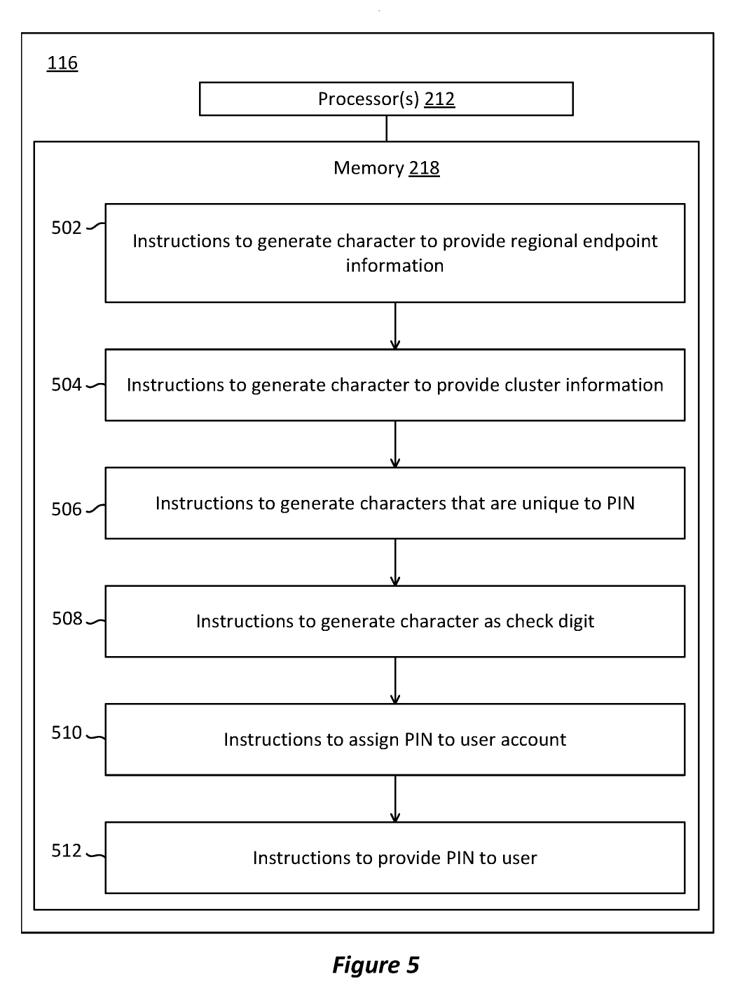

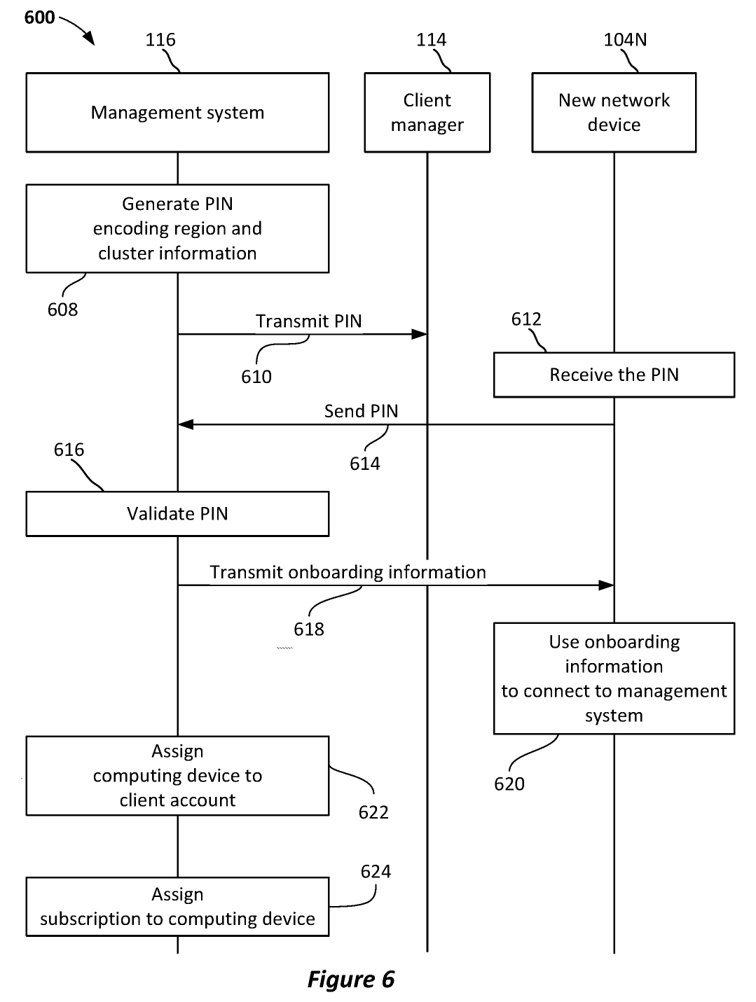

FIG. 6 depicts a sequence diagram 600 illustrating the PIN-based device onboarding process involving at least partially the following components: the management system 116, the client manager 114, and/or the new network device 104N.

In some implementations, the management system 116 performs a PIN generation step 608 to create a unique PIN for device onboarding. The PIN may encode region and/or cluster information for efficient routing.

Once generated, the PIN may be transmitted to a client manager 114, e.g., through a secure channel or user interface within the management platform. In some implementations, the management system 116 performs a first transmission step 610 to client manager 114 to provide the generated PIN to the client manager 114. The transmission may occur through a secure channel to maintain PIN confidentiality. As an example, the transmission process may involve displaying the PIN to an authorized user or sending it through a secure messaging system, allowing only for the intended recipient to have access to the PIN.

In some implementations, the new network device 104N performs a PIN receipt step 612 to obtain the PIN for onboarding the new network device 104N. The PIN may be manually entered by a user into the device interface or automatically input through a secure method into the device configuration.

In some implementations, the new network device 104N performs a second transmission step 614 to management system 116 to send the received PIN back to the management system 116 for validation. The transmission may include additional device information for verification.

In some implementations, the management system 116 performs a validation step 616 to verify the received PIN and extract encoded information. In some implementations, upon receiving the PIN, the verification engine 230 initiates a validation process. The verification engine 230 may check PIN validity, expiration, and extract regional and cluster data.

In some cases, the management system 116 may extract regional endpoint information and cluster information from specific characters of the received PIN during the validation step 616. The management system 116 may use this extracted information to route the onboarding request to the appropriate cluster within the management service.

The validation step 616 may involve one or more checks to ensure the PIN authenticity and validity. In some cases, the management system 116 may verify that the PIN has not expired and has not been previously used for onboarding another new network device. This validation may occur in multiple stages, beginning with a local check using the embedded check digit. If the local validation is successful, the new network device 104N may then attempt to connect to a regional endpoint determined by the encoded region information within the PIN. This approach may allow the new network device 104N to intelligently route its initial connection request without requiring prior knowledge of the global infrastructure.

One aspect of this validation may involve verification that the PIN is unique within a predetermined time period. In some implementations, this check allows preventing potential security risks associated with PIN reuse or collision. A validation step 616 may include confirming that the PIN has not expired. PINs may be configured with a limited validity period to improve security. In some implementations, this expiration adds a temporal dimension to the PIN security, reducing the window of opportunity for potential misuse of a compromised PIN.

In some implementations, the validation step 616 may include a check of the PIN's usage count as part of the overall validation process. This security feature allows for controlled, multi-device onboarding of the new network device 104N while maintaining the integrity of the PIN-based onboarding system 100.

During the validation step 616, the management system 116 may perform several checks, including verifying authenticity of the PIN and the number of the new network devices 104N already onboarded using this PIN. The PIN-based onboarding system 100 may maintain a counter associated with each PIN, incrementing it each time when the new network device 104N is successfully onboarded.

For example, when the PIN is generated, the maximum number of the new network devices 104N that can be onboarded with that PIN may be specified. The validation step 616 can then compare the current usage count against this specified maximum. If the count meets or exceeds the maximum, the validation may fail for any subsequent onboarding attempts.

As a specific example, if a user specifies that a given PIN can onboard five devices, the validation step 616 may track the number of successful onboarding attempts. When five devices have already been onboarded using this PIN, the validation would fail for the sixth device attempting to use the same PIN. This failure may prevent the sixth device from completing the onboarding process, effectively enforcing the user-specified limit.

The use count validation may provide several benefits. In some implementations, the use count allows for batch onboarding of multiple new network devices 104N with a single PIN, improving efficiency for large-scale deployments. In some implementations, the use count maintains security by limiting the number of the new network devices 104N that can be onboarded with a single PIN. In some implementations, the use count provides flexibility, allowing users to specify different usage limits for different PINs based on their specific needs. In some implementations, the use count prevents unauthorized use of PINs beyond their intended scope.

Upon successful validation, the information transmission step 618 may provide the new network device 104N with the appropriate data to establish a secure connection with the management service. This step may support the aspect of transmitting onboarding information to the new networking device 104N.

In some implementations, the management system 116 performs an information transmission step 618 to provide onboarding information to new network device 104N upon successful PIN validation. The information may include configuration data and credentials for secure connection.

In some implementations, the new network device 104N performs a connection step 620 to management system 116 to establish a connection with the management system 116. The connection may be made using the provided onboarding information.

In some implementations, the management system 116 performs an account assignment step 622 to automatically assign the new network device 104N to a client account. The assignment may be based on the validated PIN and associated account information.

In some implementations, the management system 116 performs a subscription assignment step 624 to automatically assign a subscription to the new network device 104N. The subscription assignment may be based on selections made during PIN generation.

The account assignment step 622 and/or subscription assignment step 624 may streamline the onboarding process by automatically configuring the new network device 104N within the client's account and service plan. The steps 622 and/or 624 may eliminate or substantially reduce the need for manual account and/or subscription setup, potentially reducing errors and/or saving time for clients and/or system administrators.

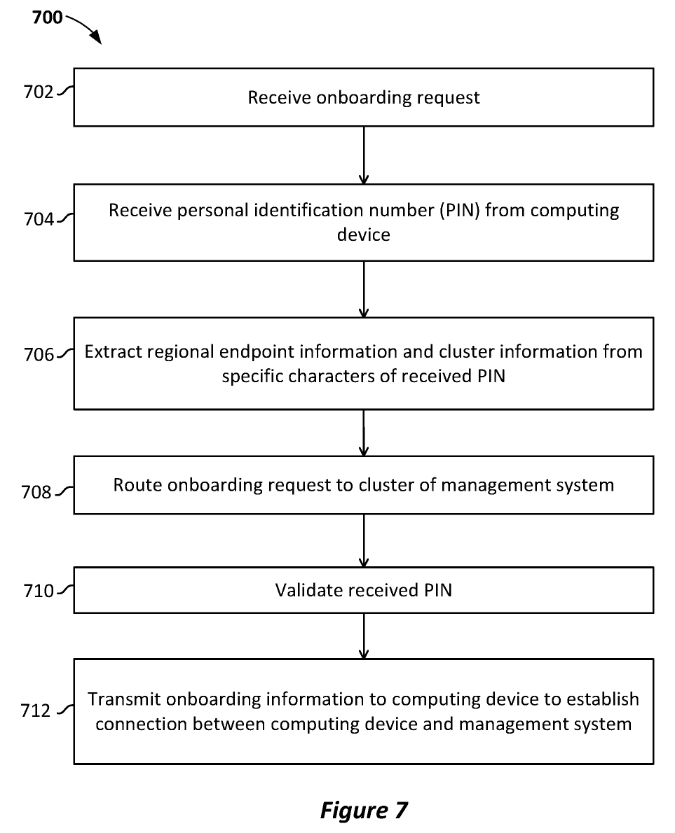

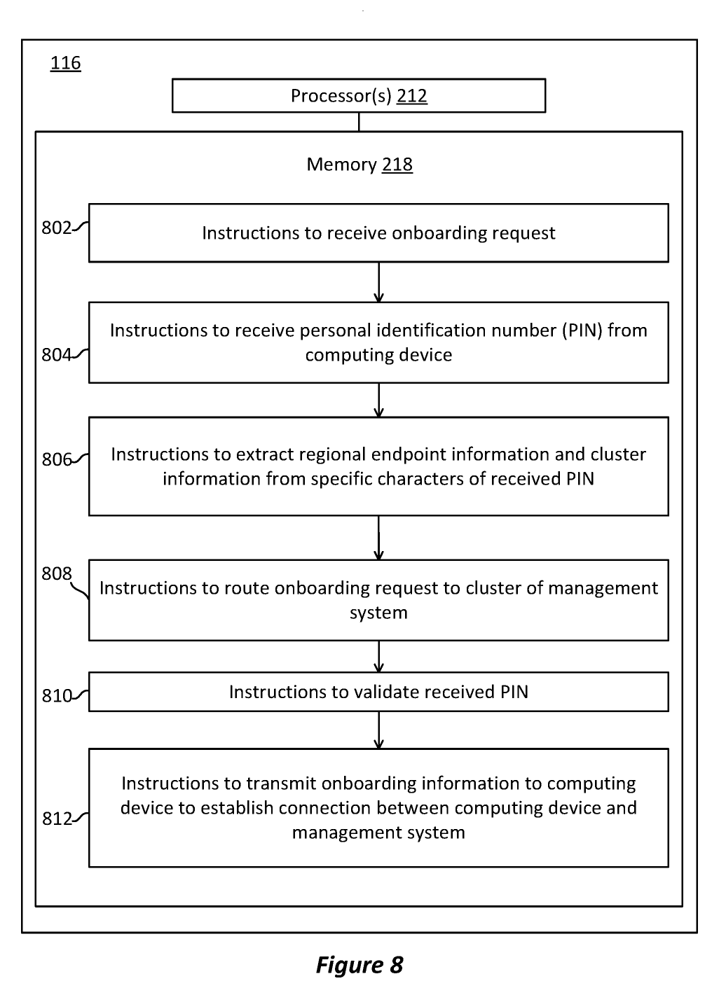

FIGS. 7 and 8 illustrate a method and system for processing PIN-based onboarding requests in a management service. FIG. 7 depicts a method 700 for processing PIN-based onboarding requests in a management service. FIG. 8 depicts the corresponding PIN-based onboarding system 116 that can implement the method 700.

The method 700 begins at step 702 (corresponding to instructions 802), where an onboarding request may be received on behalf of a computing device seeking to onboard with a management service (e.g., the management system 116). In some cases, the computing device may be a new network device 104N within a managed network 102.

In step 704 (804), a PIN may be received on behalf of the computing device. The PIN may have a plurality of characters, where specific characters of the PIN may encode regional endpoint information and cluster information associated with a management service. In some cases, the PIN may have a structure similar to the PIN structure 400 described in relation to FIG. 4.

The process continues with step 706 (806), which may involve extracting the regional endpoint information and cluster information from the specific characters of the received PIN. In some cases, the extraction process may use the region indicator 426 and cluster indicator 424 positions within the PIN structure 400.

Step 708 (808) may involve routing the onboarding request to a cluster of the management service based on the extracted regional endpoint information and cluster information. In some cases, routing the onboarding request may include accessing a mapping table using the regional endpoint information. The mapping table may contain associations between regional codes and specific endpoints within the management service.

In some implementations, while the management system 116 is described as receiving instructions to route the onboarding request to a specific region or cluster, the new network device 104N may also be configured to perform such routing independently. This self-routing capability of the new network device 104N may allow for more efficient and decentralized onboarding processes.

For example, the new network device 104N may be configured to extract the regional endpoint information encoded in the PIN and use this information to determine the appropriate regional endpoint to connect to, without requiring direct routing instructions from the management system 116. This approach may allow the new network device 104N to intelligently route its initial connection request without requiring prior knowledge of the global infrastructure.

In some cases, if the regional characters are not found in the mapping table, the new network device 104N may use any existing endpoint in the mapping table to retrieve an updated version of the table. The new network device 104N may determine that the regional endpoint information is not found in the mapping table, use an existing endpoint in the mapping table to obtain an updated mapping table, and then determine whether the regional endpoint information is found in the updated mapping table.

In step 710 (810), the received PIN may be validated. Validation of the received PIN may include using a check character to confirm accuracy of characters in other positions of the PIN. In some cases, the check character may correspond to the ninth position 418 of the PIN structure 400, as indicated by the check digit indicator 420.

The new network device 104N may perform a local validation of the PIN using the check digit prior to transmitting the PIN to the management service. In some cases, the PIN may be validated at two or more stages of the onboarding, including a local validation at the computing device, a validation at a regional endpoint, and/or a validation at an assigned cluster, providing a multi-layered verification process.

In some cases, a local validation of the PIN may be performed at the computing device, e.g., the new network device 104N, using the check digit prior to transmitting the PIN to the management service. The validation process may also include verifying that the PIN has not been previously used for onboarding a different computing device to be associated with a different user account. Additionally, the management system 116 may validate the PIN by verifying the PIN is associated with an authorized user account in the management service.

Step 712 (812) may involve transmitting onboarding information to the computing device upon successful validation, establishing a connection between the computing device and the management service. In some cases, the onboarding information may include configuration data, certificates, and credentials, which may be appropriate for secure connection of the new network device 104N to the management system 116.

The PIN-based onboarding management system 116 may provide several advantages. The management system 116 may reduce the complexity of the onboarding process from the client perspective, requiring only the input of a relatively short, easy-to-manage PIN rather than lengthy identification codes or complex manual configurations. The encoded nature of the PIN allows for intelligent routing and automatic account association without requiring the user to understand or input detailed infrastructure information. The configuration of the management system 116 may improve security through the use of cryptographically random characters, limited PIN validity periods, and/or built-in error checking. These features of the PIN- based onboarding system 100 may be resistant to common security threats while remaining user-friendly.

In some implementations, the flexibility of the PIN structure allows for future expansion of the management system 116. The region and cluster encoding can accommodate growth in the number of managed regions and clusters without requiring changes to the core onboarding process. In some implementations, such scalability allows the management system 116 to adapt to the evolving needs of global management infrastructures. By simplifying the process for end-users while maintaining relatively high levels of security and flexibility for system administrators, the PIN-based onboarding management system 116 may improve management of large-scale, geographically distributed device networks.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method comprising:
receiving an onboarding request seeking to onboard a computing device with a management system;
receiving a personal identification number (PIN) from the computing device, the PIN having a plurality of characters, wherein specific characters of the PIN encode regional endpoint information and cluster information associated with the management system;
extracting the regional endpoint information and cluster information from the specific characters of the received PIN;
routing, based on the extracted regional endpoint and cluster information, the onboarding request to a cluster of the management system based on the extracted regional endpoint information and cluster information;
validating the received PIN; and
upon successful validation, transmitting onboarding information to the computing device to establish a connection between the computing device and the management system.

2. The method of claim 1, wherein the specific characters comprise two characters to provide the regional endpoint information and one character to provide the cluster information.

3. The method of claim 1, further comprising automatically assigning the computing device to a customer account in the management system based on the validated PIN.

4. The method of claim 3, further comprising automatically assigning, to the computing device, a subscription associated with the PIN.

5. The method of claim 1, wherein routing the onboarding request to the cluster of the management system comprises accessing a mapping table using the regional endpoint information.

6. The method of claim 5, wherein routing the onboarding request to the cluster of the management system further comprises:
determining that the regional endpoint information is not found in the mapping table;
using an existing endpoint in the mapping table to obtain an updated mapping table; and
determining whether the regional endpoint information is found in the updated mapping table.

7. The method of claim 1, wherein the onboarding request is received from the computing device.

8. The method of claim 1, wherein validating the received PIN further comprises validating the received PIN at a regional endpoint or at an assigned cluster.

9. A computer-implemented method comprising:
receiving a request from a user for a PIN for use in onboarding computing devices in a management system; and
generating a personal identification number (PIN) in response to the request, the PIN having between six and twenty characters, generating the PIN comprising:
generating one or more characters to provide regional endpoint information;
generating one or more characters to provide cluster information;
generating a plurality of characters that are unique to the PIN; and
generating one or more characters as a check digit;
assigning the PIN to an account of the user; and providing the PIN to the user.

10. The method of claim 9, wherein generating the PIN comprises:
generating two characters to provide the regional endpoint information;
generating one character to provide the cluster information;
generating one character to provide the check digit; and
generating cryptographically random characters for remaining characters of the PIN.

11. The method of claim 10, wherein the PIN comprises a nine-digit PIN.

12. The method of claim 9, wherein the PIN excludes visually ambiguous characters, the visually ambiguous characters comprising "I", "1", "0", "o", and "0".

13. The method of claim 9, wherein the check digit is configured to detect errors in other characters of the PIN.

14. A computing system, comprising:
one or more processors; and
a non-transitory computer-readable medium storing programming for execution by the one or more processors, the programming comprising instructions to:
receive an onboarding request seeking to onboard a computing device with a management system;
receive a personal identification number (PIN) from the computing device, the PIN having between six and twenty characters, wherein specific characters of the PIN encode regional endpoint information and cluster information associated with the management system;
extract the regional endpoint information and cluster information from the specific characters of the received PIN;
route, based on the extracted regional endpoint and cluster information, the onboarding request to a cluster of the management system based on the extracted regional endpoint information and cluster information; and
transmit onboarding information to the computing device to establish a connection between the computing device and the management system.

15. The system of claim 14, wherein the received PIN includes a check character, wherein validating the received PIN comprises using the check character to confirm accuracy of characters in other positions of the received PIN.

16. The system of claim 14, wherein the received PIN comprises nine characters, five of the characters providing a unique PIN identifier and one character being a check character.

17. The system of claim 14, wherein the programming further comprises instructions to validate the received PIN by verifying the extracted regional endpoint information and the extracted cluster information correspond to valid regional endpoints and clusters within the management system.

18. The system of claim 14, wherein the programming further comprises instructions to validate the received PIN by verifying the received PIN has not been previously used for onboarding a different computing device to be associated with a different user account.

19. The system of claim 14, wherein the programming further comprises instructions to validate the received PIN by verifying the received PIN is associated with an authorized user account in the management system.

20. The system of claim 14, wherein the programming further comprises instructions to associate the PIN with a user subscription.
